(19) United States
(12) Patent Application Publication
(10) Pub. No.: US 2009/0060332 A1
(43) Pub. Date: Mar. 5, 2009

(54) OBJECT SEGMENTATION USING DYNAMIC PROGRAMMING

(75) Inventor: Jason Knapp, Miamisburg, OH (US)

Correspondence Address: CONNOLLY BOVE LODGE & HUTZ LLP, 1875 EYE STREET, N.W., SUITE 1100, WASHINGTON, DC, 20006, US

(73) Assignee: RIVERAIN MEDICAL GROUP, LLC, Miamisburg, OH (US)

(21) Appl. No.: 11/938,607

(22) Filed: Nov. 12, 2007

Related U.S. Application Data
(60) Provisional application No. 60/968,142, filed on Aug. 27, 2007.

(51) Int. Cl. G06K 9/34

(52) U.S. Cl. 382/173

(57) ABSTRACT

An object in an image may be segmented by determining local pixel costs based on the image and using the local costs to determined cumulative pixel costs. A contour may then be determined based on the cumulative pixel costs.

### CROSS-REFERENCE TO RELATED APPLICATION

This application claims the priority of U.S. Provisional Patent Application No. 60/968,142, filed on Aug. 27, 2007, and incorporated by reference herein.

### FIELD OF ENDEAVOR

Various embodiments of the invention may relate, generally, to the segmentation of objects from images. Further specific embodiments of the invention may relate to the segmentation of abnormalities in radiological images.

### BACKGROUND

Object segmentation is a useful tool in machine vision and image processing applications and is an on-going area of research. Object segmentation allows the application to separate an object within an image. While many such techniques have been proposed, there is much room for improvement.

### BRIEF DESCRIPTIONS OF THE DRAWINGS

Various embodiments of the invention will now be described in conjunction with the attached drawings, in which:

FIG. 1 shows a conceptual flowchart of a process according to an embodiment of the invention;

FIGS. 2A-2C show, respectively, examples of an input image, a smoothed gray scale image that may be generated in some embodiments of the invention, and a second-order variation (SOV) image that, may be generated in some embodiments of the invention;

FIGS. 3A-3D show, respectively, examples of an image with an initial detection contour, a portion of a region of interest (ROI) converted to polar coordinate representation, the portion of the ROI smoothed, and the portion of the ROI in SOV form, which variations on the image may be used in various embodiments of the invention;

FIGS. 4A-4D show, respectively, gradient, gray scale, SOV, and size costs that may be determined based on the examples shown in FIGS. 3A-3D, as may be determined in various embodiments of the invention;

FIGS. 5A and 5B show, respectively, examples of local and cumulative cost matrices that may be determined based on the costs represented in FIGS. 4A-4D, according to some embodiments of the invention;

FIGS. 6A-6C show, respectively, examples of a portion of image including an ROI, a corresponding image showing a contour that may be obtained using an embodiment of the invention, and the same image with a manually-drawn contour; and

FIG. 7 shows an exemplary system in which various embodiments of the invention, or portions thereof, may be implemented.

### DETAILED DESCRIPTION OF VARIOUS EMBODIMENTS

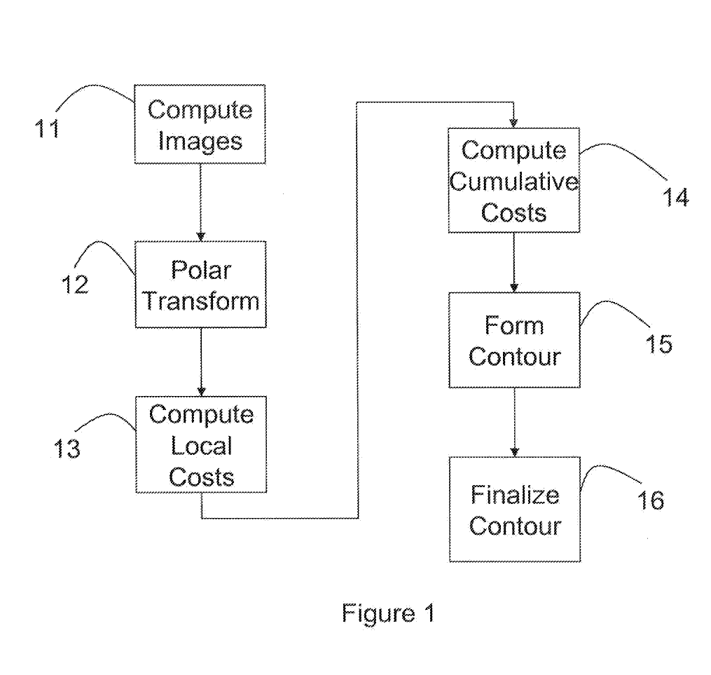

FIG. 1 shows an diagram of an embodiment of the invention. The invention may accept as input one or more native (raw or pre-processed) images. These native images may be processed to compute one or more basis images 11. The basis images may then, be used to guide the segmentation of objects; the different basis images that may be used in various embodiments of the invention are discussed further below. The basis images may then be mapped to a polar coordinate system 12 (alternatively, the basis images may be determined based on a native image that is converted to polar coordinates), which may be used to provide a convenient implementation of various embodiments of the invention.

Various embodiments of the invention may be based on the general framework of dynamic programming. These techniques may incorporate information about edges, ridges (rib edges), shape, gray scale, and size in a flexible framework rather than resorting to ad hoc rules. One concept that may be used in such embodiments of the invention is that of incorporating a cost term related to an initial size estimate. The initial estimate of size may be provided by an automated detection process and/or a manual process in which a user establishes an initial object contour. Incorporation of a cost related to an initial size estimate may be used to provide a control signal and may help to ensure stability.

In various embodiments of the invention, each pixel may be assigned a local cost 13, where a low cost may be assigned to the values of pixels that have characteristics typical of object borders (alternatively, a high cost may be assigned to these pixels and inverse techniques may be used; however, it is more intuitively clear to discuss this using a low cost for border pixels).

These characteristics may be particularly applicable, for example, to cancerous; nodules in radiological images or more generally to regions that may manifest themselves in imagery as compact, roughly circular regions that exhibit contrast (positive or negative) relative to their local backgrounds in various types of images, medical or non-medical. Examples of diseases that exhibit such characteristics in medical images may include (but are not limited to): lung cancer, breast cancer (both masses and microcalcifications) and colon polyps. Furthermore, observables of this, type may be present across various imaging modalities, including (but not limited to): computed tomography (CT), magnetic resonance imaging (MRI), positron emission tomography (PET), and tomosynthesis (3-D breast imaging).

In block 13, the local cost may be computed for each pixel using a linear combination of individual cost images as follows:

local_cost=w_{grad}*C_{grad}+wₛₒᵥ*Cₛₒᵥ+w_{gs}*C_{GS}+w_{size}*C_{size},

where C_{grad} is the cost based on a gradient magnitude, Cₛₒᵥ is the cost based on a second; order variation (SOV) image, C_{gs} is the cost based on a smoothed gray scale image, and C_{size} is the cost based on the deviation from an initial radius estimate of an object provided by a detection process (automatic or manual). Each cost term may be scaled to the zero-one range so that individual cost weights, w_{grad} for example, can be set in an intuitive manner. The cost weights may set off-line to optimize the overlap between “truth segmentations” and automated segmentations. The weights used in an exemplary implementation of an embodiment of the invention, which may be used for lung nodule segmentation, may be as follows, w_{grad}=4.5, wₛₒᵥ=3.0, w_{gs}=1.0 and w_{size}=1.0. The cost terms may be computed on-line for each extracted region of interest.

Computation of the gradient image may include any standard method of estimating first derivatives. Both the magnitude and orientation of the gradient at each pixel location in the polar format may be determined.

The SOV image may be determined based on estimates of the second-order derivatives (as will, be explained below). Shape may be estimated using the following equations:

f20=(1/sqrt(3))*(Fxx+Fyy);

f2=(sqrt(2/3))*Fxx−Fyy);

f22=2*sqrt(2/3)*Fxy;

shape=a tan(f20/sqrt(f21̂2+f22̂2));

where:
Fₓₓ is the second derivative along the image rows;
F_{yy} is the second derivative along the image columns;
F_{xy} is the derivative along the image rows followed by the derivative along the columns (i.e., the cross-derivative across rows and columns).

The smoothed gray-scale image may be determined as a low-pass filtered image, and finally, the size cost may be computed using deviation from an initial object radius as defined by an automated or manual detection process.

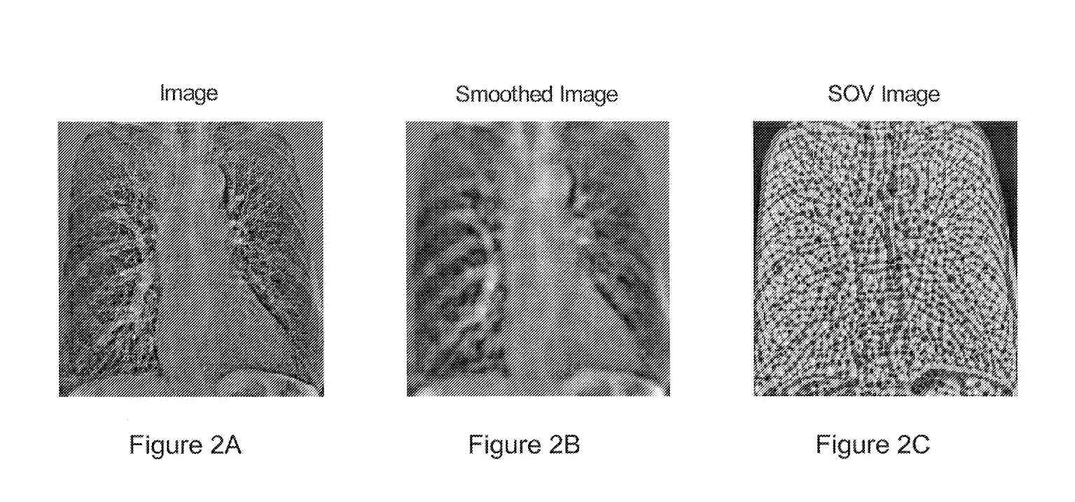

Example images of a smoothed gray scale image and a corresponding SOV image are shown in FIGS. 2B-2C. FIG. 2A shows a raw image after appropriate normalization steps have been performed; this may serve as a reference image. This image may have had standard techniques app lied to equalize contrast and to provide a fixed pixel spacing. FIG. 2B shows a low-pass filtered version (smoothed image) of the base image, and FIG. 2C shows a corresponding SOV image. The smoothed and SOV image may be used as basis images for the computation of two of the cost terms described above.

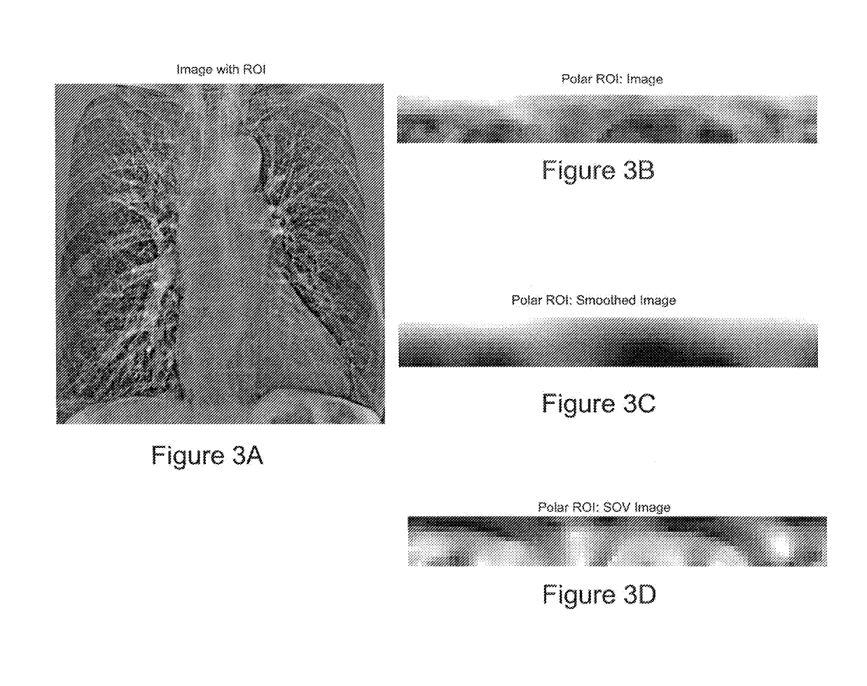

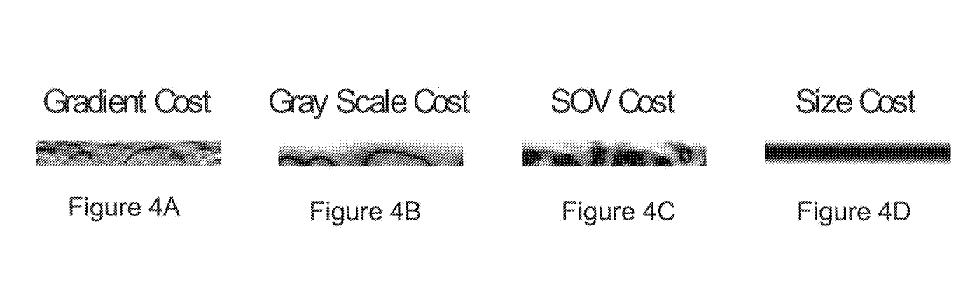

FIG. 3A shows an exemplary chest radiographic image with an initial detection contour (which may, for example, be a region of interest (ROI) determined by a computer-aided detection (CAD) method). FIG. 3B shows a portion of the ROI area of the image converted to polar coordinates. FIGS. 3C and 3D show corresponding smoothed and SOV images corresponding to FIG. 3B. FIGS. 4A-4D show respective gradient, gray scalier SOV, and size costs that may be computed based on the example of FIGS. 3A-3D, with the basis images of FIGS. 3A-3D having been mapped into a polar coordinate system.

Given the total local cost per pixel, one may then compute the cumulative cost 14. The cumulative cost accounts for both the local and transitional costs. The transitional cost weights the path of going from one pixel to the next. Typical transitional cost term may include information based on gradient orientation and/or pixel distance. A total cumulative cost matrix may be defined as follows:

C(i,1)=local_cost(i,1).

C(i,j+1)=min{C(i+s,j)+local_cost(i,j+1)+T(n1,n2s)}−k≦s≦k,

where T represents the transition cost in going from a node n1 at (i+s,j) to node n2 at (i,j+1). The value “s” is the offset between nodes when going from one column to the next. The value of this offset may not be allowed to be larger than a specified value, “k”. In some embodiments of the invention, T may be defined as follows:

T=w_{d}*dist(n1,n2)+w_{go}*|θₙ₁−θₙ₂|,
where dist(n1,n2) is the distance from n1 to n2 and w_{d} is an associated weight, and |θₙ₁−θₙ₂| is the absolute difference in the gradient orientation at n1 and n2 with w_{go} being its associated weight. These weights may, for example, be determined by the user, e.g., based on a particular application, or they may be predetermined.

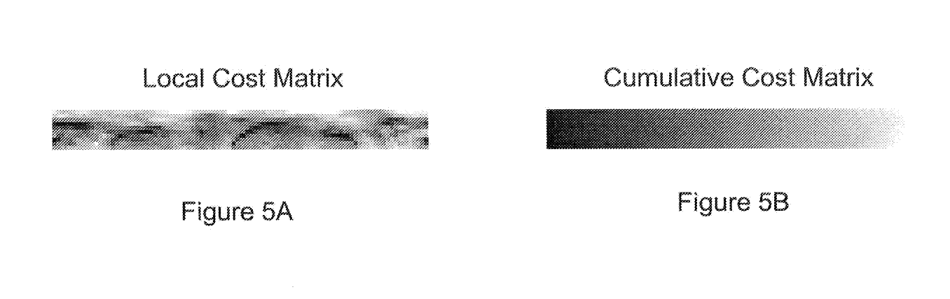

FIGS. 5A and 5B show, respectively, examples of a local cost matrix and cumulative cost matrix that may be computed based on costs shown in FIGS. 4A-4D.

Given the cumulative cost matrix, an object's contour may be formed 15 by backtracking from the point of lowest cumulative cost in the final column of the cumulative cost matrix to the first column. As the cumulative cost matrix may be computed in the polar domain, the backtracking process may amount to starting an object's contour and then moving counterclockwise, in an effort to obtain a closed contour. In other embodiments of the invention, one may, in general, begin with an extreme row or column of the matrix and proceed either clockwise or counterclockwise.

Once the object's contour has been formed, one may then finalize the contour 16, to ensure that it is both closed and smooth. An object's contour is considered closed if the starting and ending coordinates are within a certain distance of each other. If the object is not closed, an additional contour search may be performed from the end with the lowest local cost, checking for intersection with the initial contour. If the contour could not be closed, then the input object may be left unchanged, and its original pixels may be used as the segmentation; in an exemplary implementation of an embodiment of the invention this has happened less than 1% of the time. Finally, the object's contour may be smoothed with a filter, which may be a Gaussian filter in some embodiments of the invention, in order to remove any unnatural roughness; this may generally be a slight level of smoothing, so as not to distort object contours.

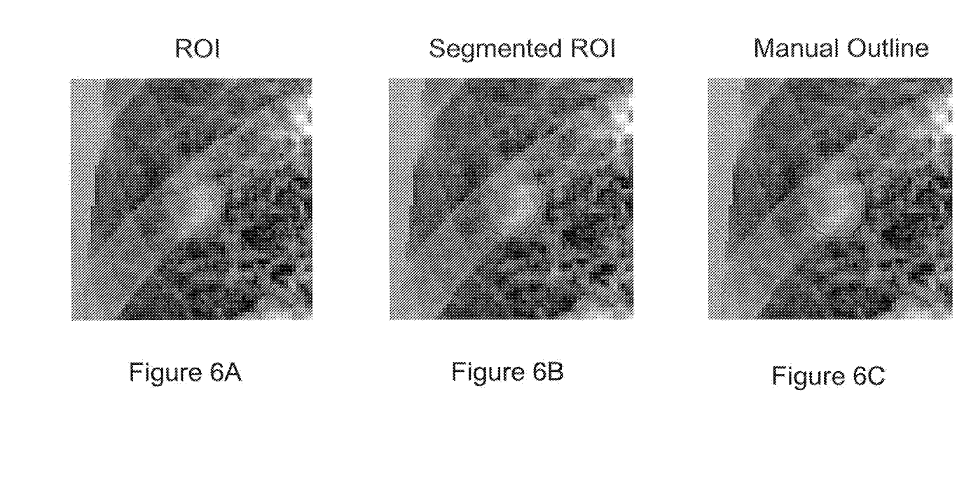

FIGS. 6A-6C show an example of images associated with an exemplary implementation of an embodiment of the invention that was used, in segmenting lung abnormalities in chest radiographs. FIG. 6A shows a sub-portion of an image that includes an ROI; this ROI may have been determined using, either an automated or manual process and may serve as a detection cue (size reference) for determining size cost in block 13. FIG. 6B shows a corresponding image in which the above procedures were used to determine a contour for the ROI. FIG. 6C, shown for comparison, shows a corresponding image in which a human created a contour for the ROI. This demonstrates that the procedures discussed above may come quite close to the “truth segmentation,” which is the manual segmentation performed by a human.

While the image illustrations have shown the use of the disclosed techniques in connection with the segmentation of lung abnormalities chest images, such techniques may also be applied to other radiological images and to non-radiological image, as well.

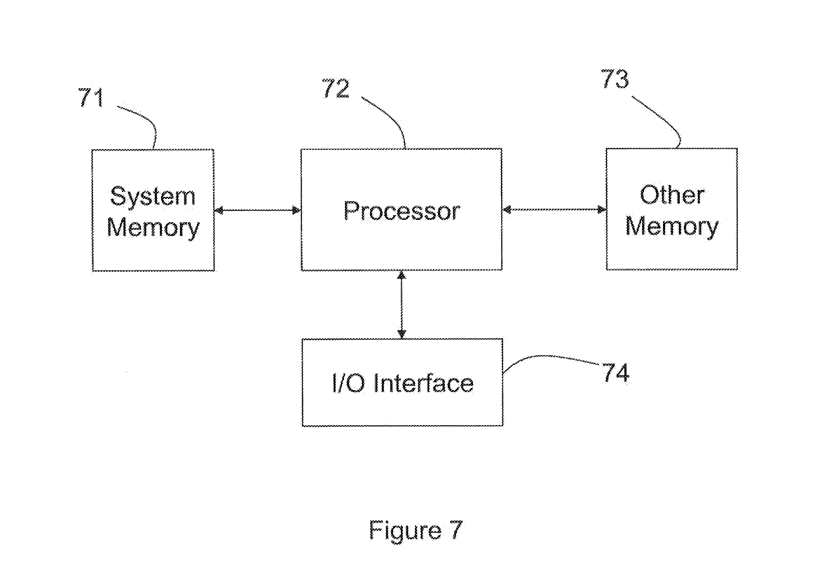

Various embodiments of the invention may comprise hardware, software, and/or firmware. FIG. 7 shows an exemplary system that may be used to implement various forms and/or portions of embodiments of the invention. Such a computing system may include one or more processors 72, which may be coupled to one or more system memories 71. Such system memory 71 may include, for example, RAM, ROM, or other such machine-readable media, and system memory 71 may be used to incorporate, for example, a basic I/O system (BIOS), operating system, instructions for execution by processor 72, etc. The system may also include further memory 73, such as additional RAM, ROM, hard disk drives, or other processor-readable media. Processor 72 may also be coupled to at least one input/output (I/O) interface 74. I/O interface. 74 may include one or more user interfaces, as well as readers for various types of storage media and/or connections to one or more communication networks (e.g., communication interfaces and/or modems), from which, for example, software code; may be obtain ed.

Various embodiments of the invention have been presented above. However, the invention is not intended to be limited to the specific embodiments presented, which have been presented for purposes of illustration. Rather, the invention extends to functional equivalents as would be within the scope of the appended claims. Those skilled in the art, having the benefit of the teachings of this specification, may make numerous modifications without departing from the scope and spirit of the invention in its various aspects.

We claim:

1. A method of object segmentation in an image, the method comprising:
computing at least one cost image based on the image;
forming a set of cumulative costs based on the at least one cost image; and
forming a contour based on the cumulative costs.

2. The method according to claim 1, further comprising:
converting the image to polar representation prior to computing said at least one cost image, and wherein at least one cost image is computed based on the polar representation of the image.

3. The method according to claim 1, further comprising:
forming a smoothed gray-scale image based on the image,
wherein at least one cost image is determined based on the smoothed gray-scale image.

4. The method according to claim 1, further comprising:
forming a second-order variation (SOV) image based on the image,
wherein at least one cost image is determined based on the SOV image.

5. The method according to claim 1, wherein there are at least two cost images, and wherein the method further comprises:
determining an overall local cost per pixel as a weighted sum of corresponding pixels of said cost images,
wherein said cumulative costs are formed based on the overall local cost per pixel.

6. The method according to claim 1, wherein said set of cumulative, costs is formed based on a set of local costs based on said at least one cost image and a set of transitional costs between pixels.

7. The method according to claim 6, wherein said transitional costs are based on at least one measure selected from the group consisting of: a distance between two pixels and an absolute difference in gradient orientation between two pixels.

8. The method according to claim 1, wherein said forming a contour comprises:
starting with a point of lowest cumulative cost at a first or last column or row corresponding to a suspected region of interest in the image, forming said contour by following adjacent pixels of lowest cost.

9. The method according to claim 8, further comprising:
finalizing the contour, wherein said finalizing comprises at least one operation selected from the group consisting of: (a) ensuring that the contour is, to within a predetermined tolerance, a closed contour; and (b) smoothing the contour.

10. The method according to claim 1, further comprising:
downloading software that, when executed, causes a processor to implement said computing at least one cost image based on the image, said forming a set of cumulative costs based on the at least one cost image; and said forming a contour based on the cumulative costs.

11. A computer-readable medium containing software that, when executed by a processor, causes the processor to implement a method of object segmentation in an image, the method comprising:
computing at least one cost image based on the image;
forming a set of cumulative costs based on the at least one cost image; and
forming a contour based on the cumulative costs.

12. The medium according to claim 11, wherein the method further comprises:
converting the image to polar representation prior to computing said at least one cost image, and wherein at least one cost image is computed based on the polar representation of the image.

13. The medium according to claim 1 wherein the method further comprises:
forming a smoothed gray-scale image based on the image,
wherein at least one cost image is determined based on the smoothed gray-scale image.

14. The medium according to claim 11, wherein the method further comprises:
forming a second-order variation (SOV) image based on the image,
wherein at least one cost image is determined based on the SOV image.

15. The medium according to claim 11, wherein there are at least two cost images, and wherein the method further comprises:
determining an overall local cost per pixel as a weighted sum of corresponding pixels of said cost images,
wherein said cumulative costs are formed based on; the overall local cost per pixel.

16. The medium according to claim 11, wherein said set of cumulative costs is formed based on a set of local costs based on said at least one cost image and a set of transitional costs between pixels.

17. The medium according to claim 16, wherein said transitional costs are based on at least one measure selected from the group consisting of: a distance between two pixels and an absolute difference in gradient orientation between two pixels.

18. The method according to claim 11, wherein said forming a contour comprises:
starting with a point of lowest cumulative cost at a first or last column or row corresponding to a suspected region of interest in the image, forming said contour by following adjacent pixels of lowest cost.

19. The method according to claim 18, further comprising:
finalizing the contour, wherein said finalizing comprises at least one operation selected from the group consisting of: (a) ensuring that the contour is, to within a predetermined tolerance, a closed contour; and (b) smoothing the contour.
